(19) United States
(12) Patent Application Publication
(10) Pub. No.: US 2002/0173990 A1
(43) Pub. Date: Nov. 21, 2002

(54) System and method for managing interactions between healthcare providers and pharma companies

(76) Inventor: Dominic A. Marasco, Newtown, PA (US)

Correspondence Address: John F. Letchford, Klehr, Harrison, Harvey, Branzburg & Ellers LLp, 260 South Broad Street, Philadelphia, PA, 19102, US

(21) Appl. No.: 10/145,552

(22) Filed: May 14, 2002

Related U.S. Application Data
(60) Provisional application No. 60/290,901, filed on May 15, 2001.

(51) Int. Cl. G06F 17/60

(52) U.S. Cl. 705/2

(57) ABSTRACT

A system and method for managing interactions between healthcare providers and pharmaceutical, biotechnology, medical supply, lab and other healthcare supply and service companies (“Pharma”). The system and method incorporates a model of fair market compensation for healthcare providers for professional time spent with members of Pharma and Pharma sales professionals, including but not limited to face-to-face interactions and appointment management. Preferably, the invention enables providers to select days and times to meet with Pharma representatives which are most convenient to the providers and non-disruptive to their patient-practice flow. Conversely, the system and method provides cost-efficient means by which Pharma and Pharma sales professionals have greater access and more meaningful time with providers while decreasing the costs associated with accessing providers.

### CROSS-REFERENCE TO RELATED APPLICATION(S)

This application claims the benefit of U.S. Provisional Application No. 60/290,901, filed May 15, 2001, entitled SYSTEM AND METHOD FOR MANAGING THE INTERACTIONS BETWEEN A HEALTHCARE PROVIDER AND A SUPPLY COMPANY, the disclosure of which is incorporated herein in its entirety by reference thereto.

### FIELD OF THE INVENTION

The present invention relates to in general to systems and methods for managing interactions between commodities providers and their customers and, in particular, to systems and methods for managing interactions between healthcare providers and pharmaceutical, biotechnology, medical supply, lab and other healthcare supply and service companies.

### BACKGROUND OF THE INVENTION

The healthcare market has changed dramatically since the mid-1980s. Managed care has forced healthcare providers to practice in a very different way than may have practiced a decade ago. As used herein, “healthcare provider” or, simply, “provider” shall be interpreted to include any individual healthcare specialist, provider or ancillary provider as well as a hospital, teaching institution, assisted care facility, skilled care facility, nursing home facility, Independent Physicians Association (IPA), Physician's Hospital Organization (PHO) (IPA and PHO are associations of healthcare providers from single or multi-specialty practices that are owned by a hospital or institutional organization and may be owned/managed by their member healthcare providers and/or the hospital or institutional organization), Managed Care Organization (MCO), Management Service Organization (MSO) or any other individual or entity that offers healthcare services. A majority of providers have seen a decrease in reimbursements from third party payers. As a consequence, in order to maintain the same lifestyle and financial independence they had in the mid 1980s and early 1990s, individual healthcare providers today commonly see as many as 30 to 45 patients a day compared to 20 patients several years ago. All of this has been occurring while these same providers have watched their office and practice administrative costs increase.

Additionally, to keep abreast of developments in pharmaceutical, biotechnology, medical supply, lab and other healthcare supplies and services, healthcare providers must spend considerable time with healthcare industry sales representatives. From the healthcare providers' perspective, the more time that is spent with members of the healthcare sales profession the less time is available to devote to patients and to promote the growth of their practices. In this current healthcare climate, therefore, providers continue to seek ways to optimize the use of their time.

Similarly, for pharmaceutical, biotechnology, medical supply, lab and other healthcare supply and service companies, hereinafter individually and collectively referred to as “Pharma”, the cost of competing against patients and other sales professionals for provider time is becoming increasingly unmanageable and inefficient. Like healthcare providers, Pharma have seen a tremendous change in the industry since the rapid increase of managed care in major healthcare markets around the country. Ten to fifteen years ago, Pharma paid little attention to the cost associated with the customary practice of “entertainment of providers” which occurred on a regular basis by their representatives. Today, Pharma is looking for better, more effective, less expensive and more structured ways to meet with providers and to better manage their representatives to increase product market share. Profit margins are shrinking and the cost of building a sales force is becoming prohibitive for much of Pharma. Additionally, Pharma must comply with relevant state and federal laws regarding marketing and promotional practices. Government regulations strictly dictate acceptable methods of marketing to providers and Pharma companies may face substantial penalties for violating these laws.

As of 1999, Pharma have seen their collective sales and marketing budgets grow to an aggregate budget of $11 billion. They have had to spend billions of dollars attempting to keep pace with their competition in selling products to the healthcare provider communities. Today, much of Pharma practices a sales technique known as “frequency”. They recognize that few of their representatives are getting meaningful face time with the providers. Therefore, they attempt to flood the market with numerous representatives in an attempt to keep in regular contact with providers, i.e. if the first representative cannot successfully access a provider, the second or third eventually will. To illustrate, in the mid to late 1980s the average sales territory may have had one or two representatives. Today, these territories are seeing as many as five representatives per company attempting to access the provider in as many ways and as many times as possible. These inefficient sales techniques come at a tremendous cost to Pharma. And, smaller pharmaceutical, biotechnology, and medical equipment supply companies may be especially impacted because they generally have a much smaller budget to spend on accessing and entertaining healthcare providers.

An advantage exists therefore for an efficient system and method for managing interactions between healthcare providers and Pharma which is fair and relatively unburdensome to healthcare providers and Pharma of all types and sizes.

### SUMMARY OF THE INVENTION

The present invention provides an efficient system and method for managing interactions between healthcare providers and Pharma incorporating a model of fair market compensation for healthcare providers for professional time spent with members of Pharma and Pharma sales staff, including but not limited to face-to-face interactions and appointment management. Preferably, the invention enables providers to select days and times to meet with Pharma representatives which are most convenient to the providers and non-disruptive to their patient-practice flow. Conversely, the system and method provides cost-efficient means by which Pharma and Pharma sales professionals have greater access and more meaningful time with providers while decreasing the costs associated with accessing providers.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments shown, by way of example only, in the accompanying drawings wherein:

FIG. 1 is a schematic overview of typical events that occur among a participating healthcare provider, a participating Pharma representative and a central management entity (CME) when using the system and method for managing interactions between healthcare providers and Pharma companies according to the present invention;

FIG. 2 is a schematic illustration of a presently preferred system for managing interactions between healthcare providers and Pharma companies according to the present invention;

FIGS. 3A and 3B are representations of graphical user interface (GUI) images of a presently preferred embodiment of a CME website with which participants of the present system may interact in order to register with and login to the system;

FIG. 4 is a flow chart depicting the manner in which a healthcare provider registers with the system;

FIGS. 4A-4E are representations of GUI images of a presently preferred embodiment of a CME website with which healthcare providers may interact in order to input and modify personal information;

FIG. 5 is a flow chart depicting the manner in which a Pharma sales representative registers with and logs on to the system;

FIGS. 5A-5C are representations of GUI images of a presently preferred embodiment of a CME website with which Pharma sales representatives may interact in order to input and modify personal information;

FIG. 6 is a flow chart depicting the manner in which a Pharma district manager registers with and logs on to the system;

FIG. 7 is a flow chart depicting the manner in which healthcare providers and Pharma sales representatives may search for specific members of the other community that are participants in the system;

FIG. 7A is a representation of GUT image of a presently preferred embodiment of a CME website with which Pharma sales representatives search for specific system participants in the healthcare provider community;

FIG. 8 is a flow chart depicting the manner in which healthcare providers may input their appointment scheduling availability into the system;

FIGS. 8A-8G are representations of GUT images of a presently preferred embodiment of a CME website with which healthcare providers or their office managers may interact in order to input and modify providers' appointment scheduling availability and with which Pharma sales representatives may interact in order to schedule appointments with healthcare providers;

FIG. 9 is a flow chart depicting the manner in which the system charges a Pharma sales representative an appointment fee upon scheduling an appointment with a healthcare provider;

FIG. 10 is a flow chart depicting the manner in which the system remits fair market value payment to a healthcare provider upon the healthcare provider's completion and submission of a post-appointment survey relating to an appointment a completed appointment with a Pharma sales representative; and

FIG. 10A is a representation of GUI image of a presently preferred embodiment of a CME website with which healthcare providers may interact in order to complete and submit an electronic survey to the CME upon completion of an appointment with a Pharma sales representative.

### DETAILED DESCRIPTION OF THE INVENTION

According to the invention, the system and method preferably comprises a central management entity (“CME”) that functions as an impartial and unbiased intermediary or liaison between “Pharma”, their sales staff and health care providers by addressing the needs and concerns of all parties equally and effectively. The CME provides time consultation, scheduling, management and data warehousing services as an unbiased intermediary The system incorporates a model of fair market compensation to providers for professional time spent with Pharma.

The model has value in effectively managing the relationship between providers and Pharma. Although the model may be wholly or partially web-implemented, according to a presently preferred embodiment it may be accomplished via a telephonic and web-enabled platform and data model implemented by the CME which is accessible by Pharma and providers. A mechanism is maintained whereby Pharma representatives are guaranteed allotted time with healthcare providers while the providers receive fair market value compensation for their professional time spent with Pharma and Pharma sales professionals. Compilation of data from various sources define fair market value compensation. In order to receive fair market value compensation, a provider (1) allocates time for a scheduled appointment with a Pharma representative, (2) completes the appointment, and (3) completes at least one of a telephonic, paper-based or web-enabled post-meeting survey following the appointment, desirably immediately following the appointment. The post-meeting survey serve as one of the resources utilized to gather market data and information for Pharma. Preferably, Pharma companies have the capability to directly access and review completed provider post-meeting surveys. These post-interaction surveys provide valuable and timely feedback to Pharma companies. Using the surveys Pharma companies may assess healthcare providers' feedback on the content delivered by and effectiveness of each member of their sales force, thereby enabling Pharma to evaluate the professionalism and economic effectiveness of their sales representatives.

The system and method provides a dedicated schedule and time period in which the sales professionals will be able to meet face-to-face with both key and no-see healthcare providers (i.e., providers that are historically known for not seeing sales professionals). When embraced by healthcare providers and Pharma, the present system model can maximize the effectiveness of Pharma sales professionals, improve the quality of the sales presentation being delivered, create a better-prepared and more interactive medical discussion and optimize the sales expenditures and budgets of Pharma companies. The schedule and time period model also allows an efficient exchange of medical information with healthcare providers within a structured environment.

Preferably, the present system provides time management and scheduling services via a web-based scheduling application residing at a designated Uniform Resource Locator (URL) offered by the CME or telephonically by calling a toll free professional services number of the CME. As is known, A URL is the address of a file (resource) accessible on the Internet. The CME acts as a scheduling intermediary for Pharma sales professionals looking to access providers that are registered with the CME and that have established certain days and times in which they agree to meet with members of the Pharma sales profession.

The CME charges Pharma companies fees upon confirmation of scheduled appointments between Pharma sales professionals and healthcare providers, regardless of whether the appointments are arranged telephonically or via the CME website. The appointment fee is preferably uniform for all scheduled appointments, although the fee may vary based on the location or specialty of the provider. The fee may also be periodically adjusted as economic forces may dictate. At its option, the CME may charge a registration fee or annual membership fee to either or both of its registered healthcare providers and sales professionals.

To promote system efficiency and fairness to participating sales professionals providers, it is desirable that sales professionals be permitted to schedule or cancel an appointment with a provider up to a certain time, e.g., 24 hours, before the prospective appointment after which time an appointment cannot be cancelled. In order to limit excessive scheduling conflicts/cancellations, payment delays or other abuses of the system by either the healthcare providers or sales professionals, the CME should also preferably employ a well-defined and strictly enforced penalty policy, including but not limited to termination of those participants who repeatedly violate the policy.

The present system and method further seeks to optimize fairness in access to healthcare providers by Pharma companies of all sizes and marketing budgets. To achieve this end and in order to maintain the CME as an unbiased intermediary among the participating Pharma companies and healthcare providers, the system and method contemplates the implementation of a policy to equitably allocate the availability of healthcare providers to Pharma sales professionals. Such a policy should restrict any single Pharma company from scheduling greater than a predetermined percentage, e.g., 20%, of all available appointments per month per provider. For example, when a sales professional of a particular Pharma company attempts to schedule and confirm an appointment with a registered provider, and that sales professional's company has reached its quota of allowable appointment slots, the CME should inform the sales professional of the policy, prevent the scheduling of the appointment and make available to the sales professional the names, dates and times of other sales professionals of the same Pharma company that are currently scheduled with the desired provider for that month. However, the interested sales representative may be placed on a waiting list. In that event, should one or more sales professionals of his or her Pharma company subsequently cancel appointment(s) with the desired healthcare provider, the previously denied sales representative(s) should be permitted to schedule and confirm appointment(s) with the provider up to the point that their Pharma company's schedule allotment with that provider is reached.

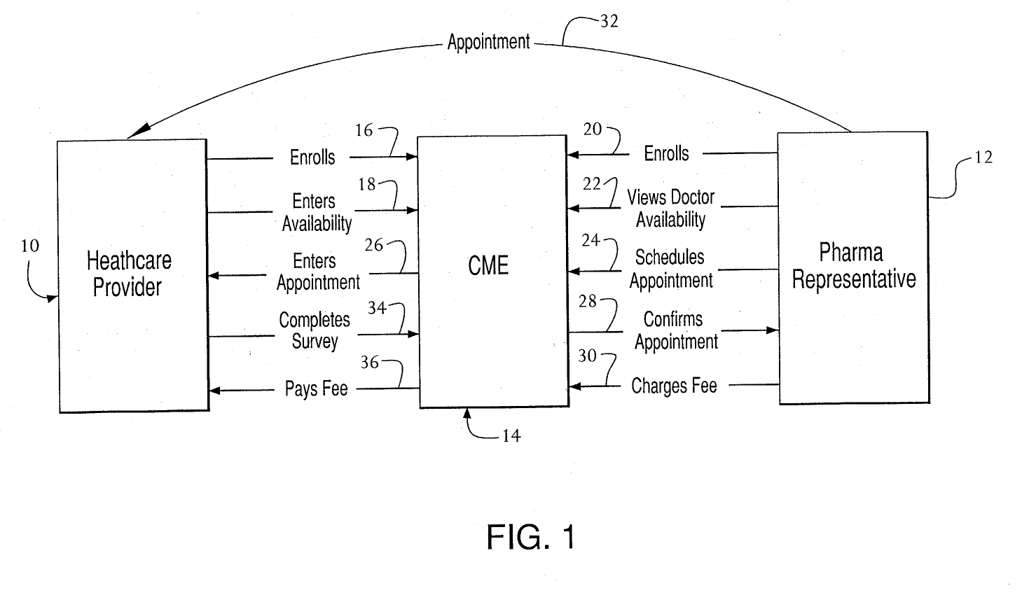

Referring now to the drawing figures, wherein like or similar references represent like or similar elements throughout the several views, there is shown in FIG. 1 a generalized and simplified schematic overview of typical events that occur among a participating healthcare provider, a participating Pharma representative and the CME when using the system and method according to the present invention for managing interactions between healthcare providers and Pharma companies. FIG. 1 depicts the interplay between a single healthcare provider such as a medical doctor 10, a single Pharma sales representative 12 and the CME 14. It will be understood, however, that the transactions shown in FIG. 1 constitute a single simplified example of potentially limitless interactions that might occur essentially continuously between any number of providers 10 and Pharma representatives 12 with CME 14 at any point in time.

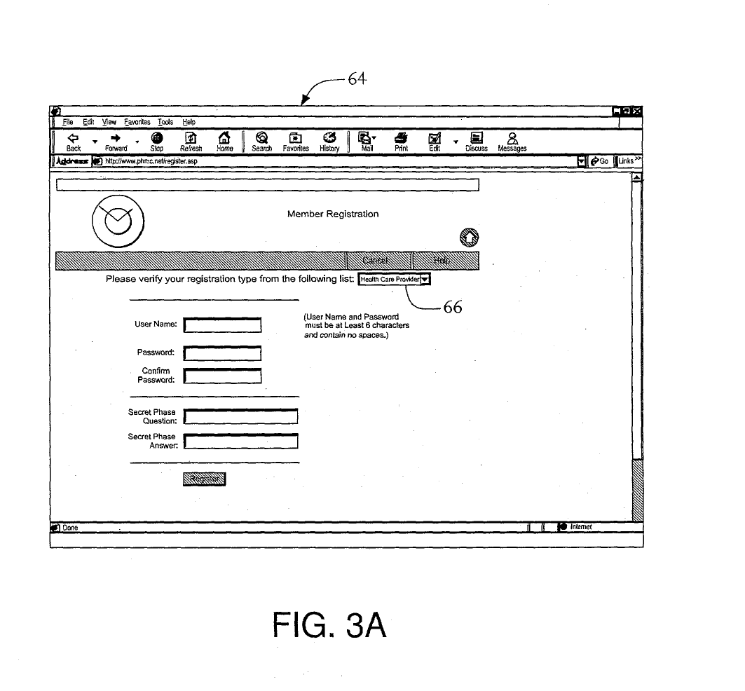

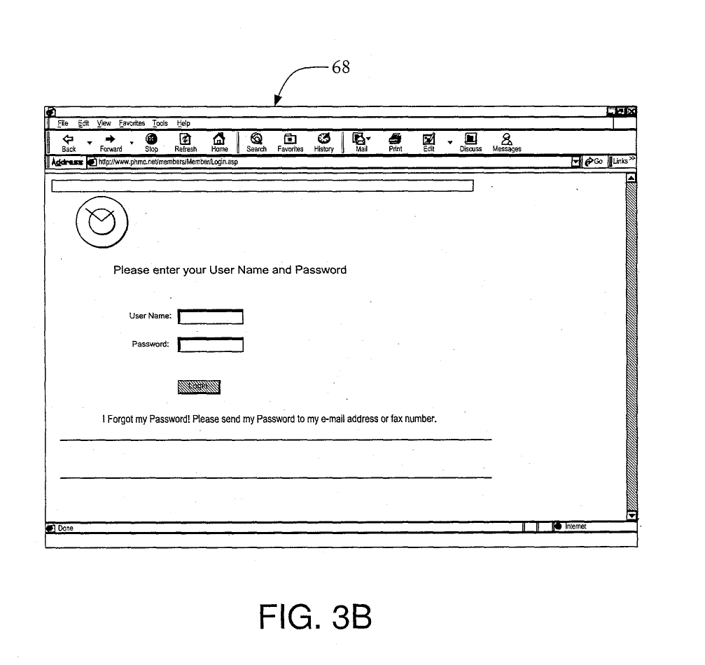

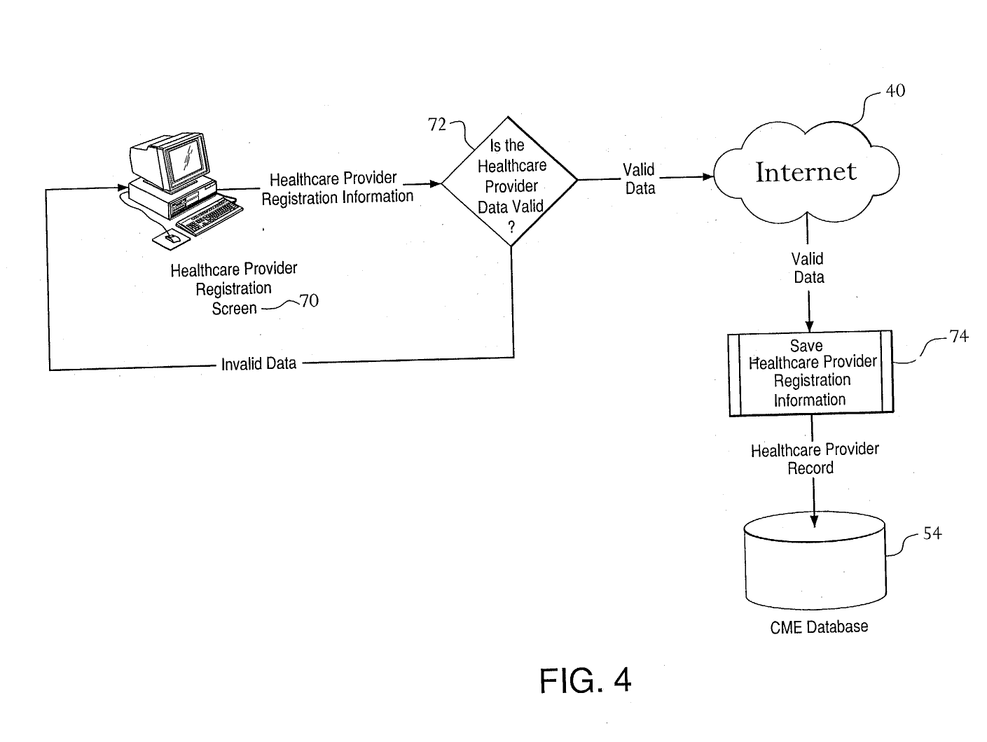

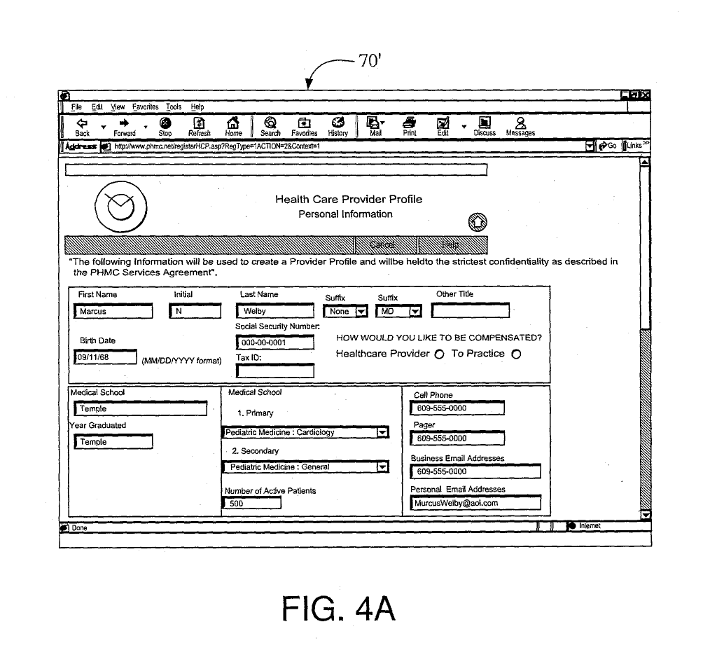

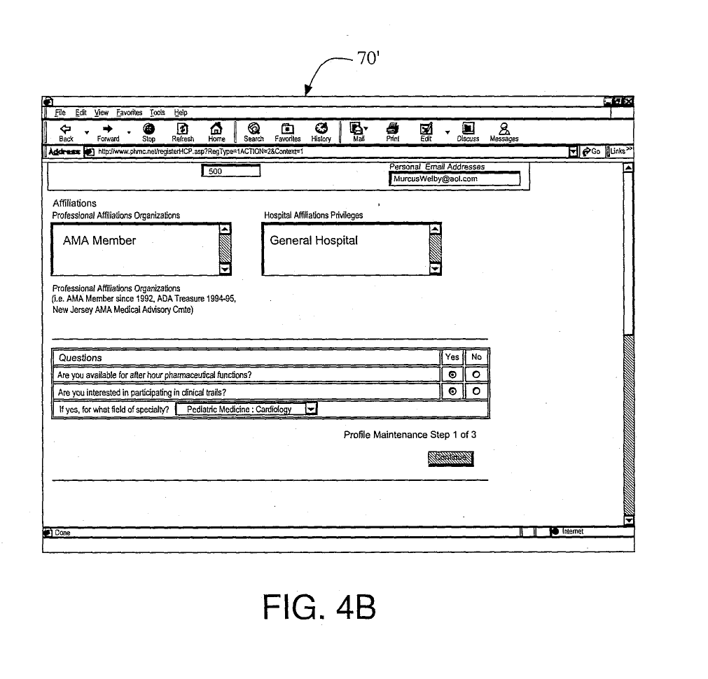

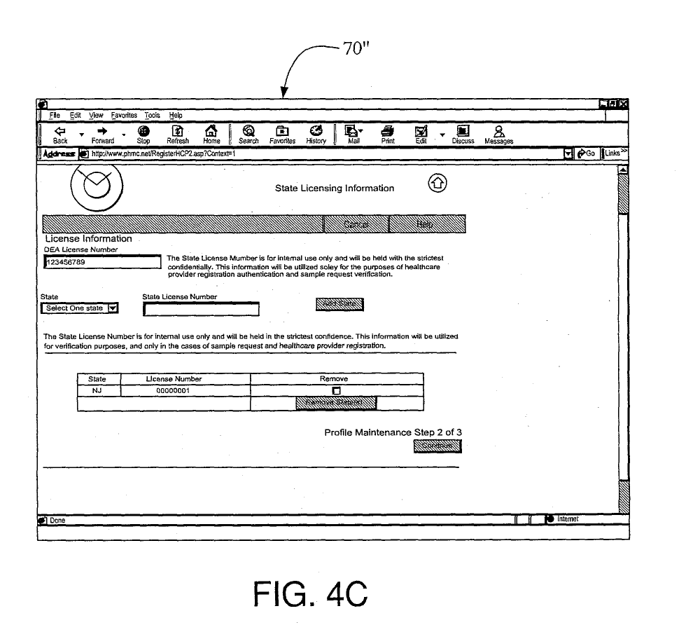

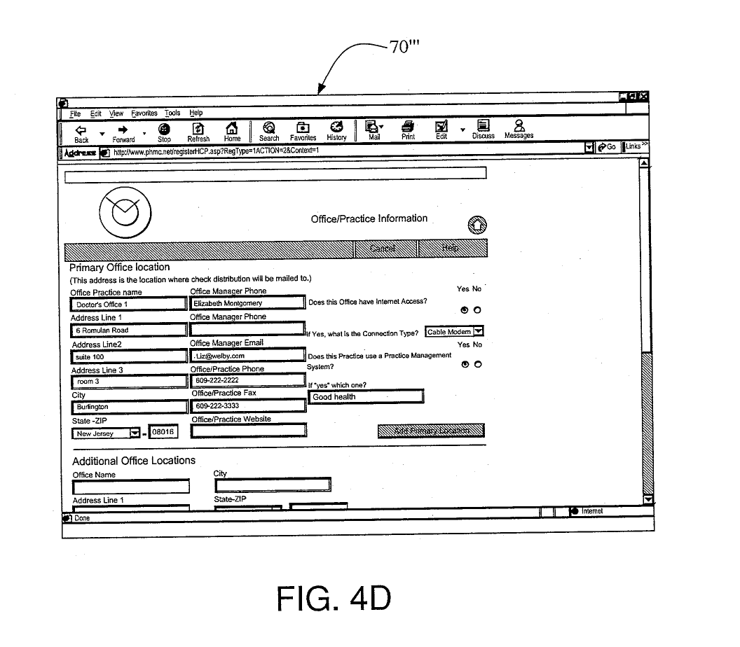

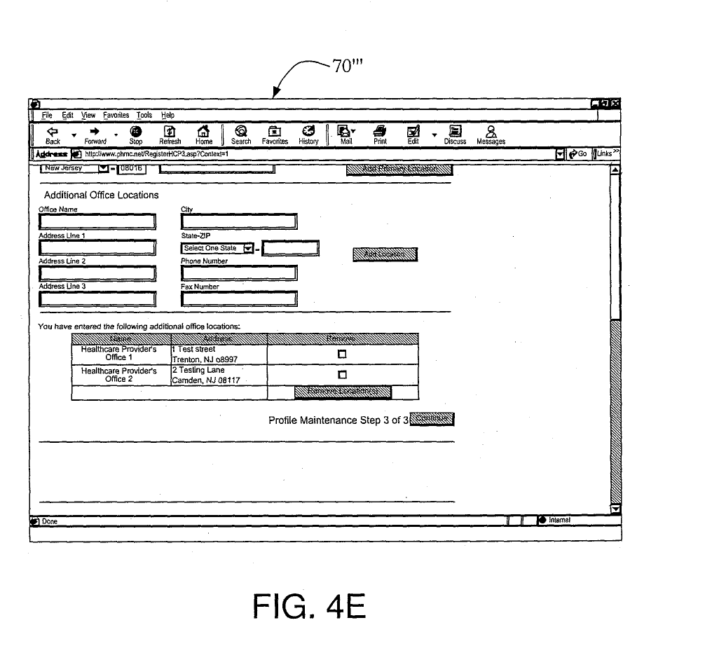

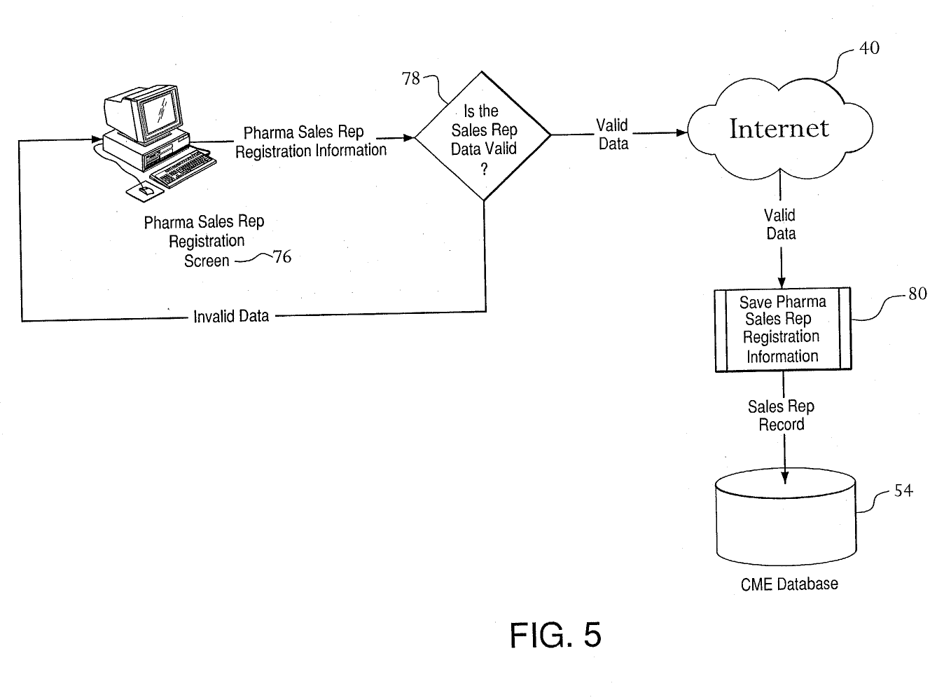

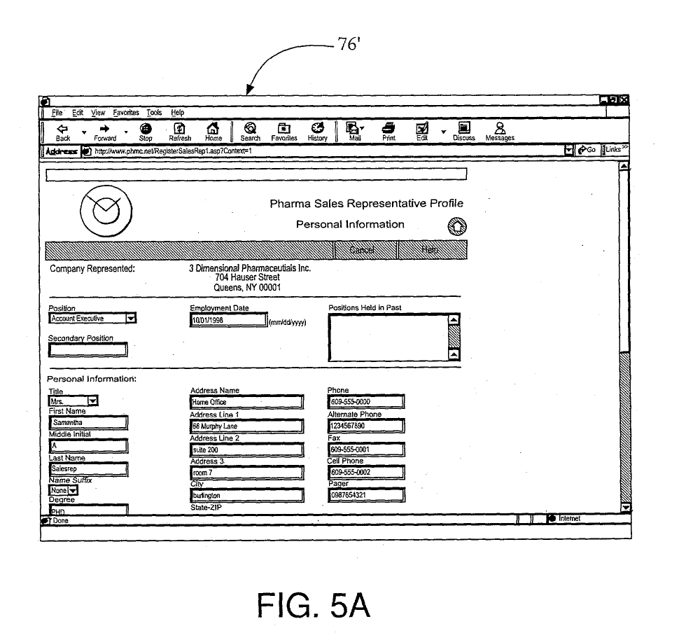

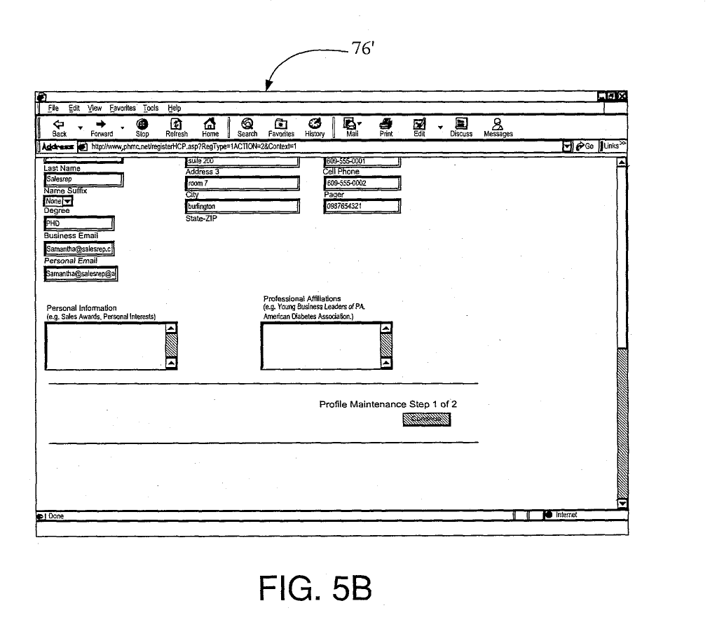

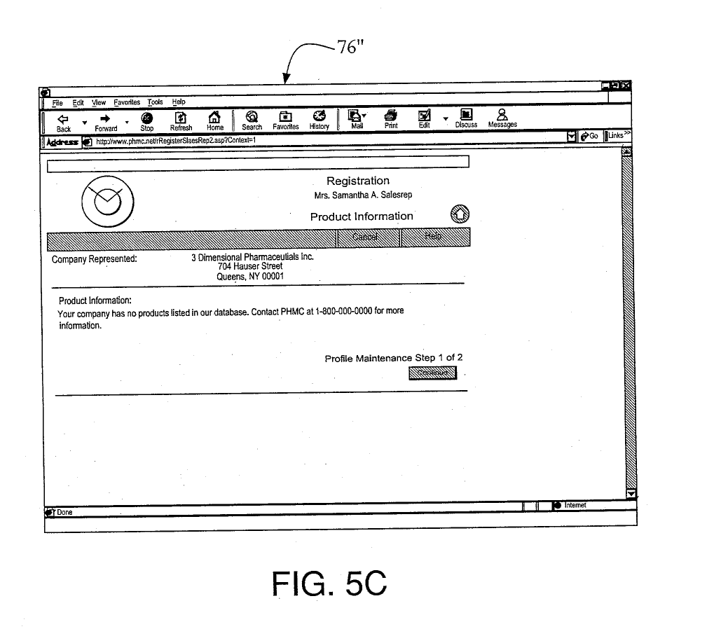

Beginning at step 16, a healthcare provider 10 such as a medical doctor electronically enrolls with the CME and establishes a personalized user profile using an Internet connection as described in greater detail in connection with FIGS. 3A-4G. Upon enrollment or registration with the CME, the CME creates a personalized electronic user appointment log for the healthcare provider. At step 18 the provider provides places, dates and times in his or her appointment log at which he or she would be willing to meet with Pharma representatives. As described in greater detail in connection with FIGS. 5A-5C, at step 20 a Pharma sales representative similarly electronically enrolls/registers with the CME and establishes a personalized user profile. As part of his or her user profile, the Pharma representative provides credit information necessary to establish a business account with the CME through which the CME charges the Pharma representative a predetermined appointment fee for each appointment he or she places through the CME. In actual operation, Pharma representatives may enroll before, concurrently or after health care providers, and vice versa. However, when a Pharma representative seeks to schedule an appointment with a particular healthcare provider, that provider must first enroll/register with the CME and post his or her availability before the Pharma representative may schedule an appointment with him or her.

At step 22 the Pharma representative views the healthcare provider's available appointment slots and at step 24 schedules an appointment with the CME to meet with the provider. The CME stores the desired appointment and at step 26 enters the appointment in the healthcare provider's appointment log. At step 28, the CME confirms the scheduled appointment with the Pharma representative. Upon confirmation of the appointment, the Pharma representative's credit card or employer company is automatically charged an appointment fee by the CME, which fee is the fair market value fee that is ultimately paid to the healthcare provider, as well as a scheduling fee which is paid to the CME. The fair market fee paid to the provider is preferably derived by objective guidelines such as those established by the Medical Group Management Association (MGMA) and the Centers for Medicare and Medicaid Services (CMS).

At step 32, the Pharma representative physically meets with the healthcare provider at the designated time and place of the appointment. Following the appointment, the provider at step 34 responds to an electronic survey relating to the meeting. After the survey is completed and submitted to the CME, the CME at step 36 pays a predetermined fair market value fee to the provider in order to compensate the provider for his or her time spent in conducting the appointment. The CME may be configured to pay the appointment fee to the provider, at the provider's option, via an electronic deposit to an account of the provider's choice or via check or similar means of payment.

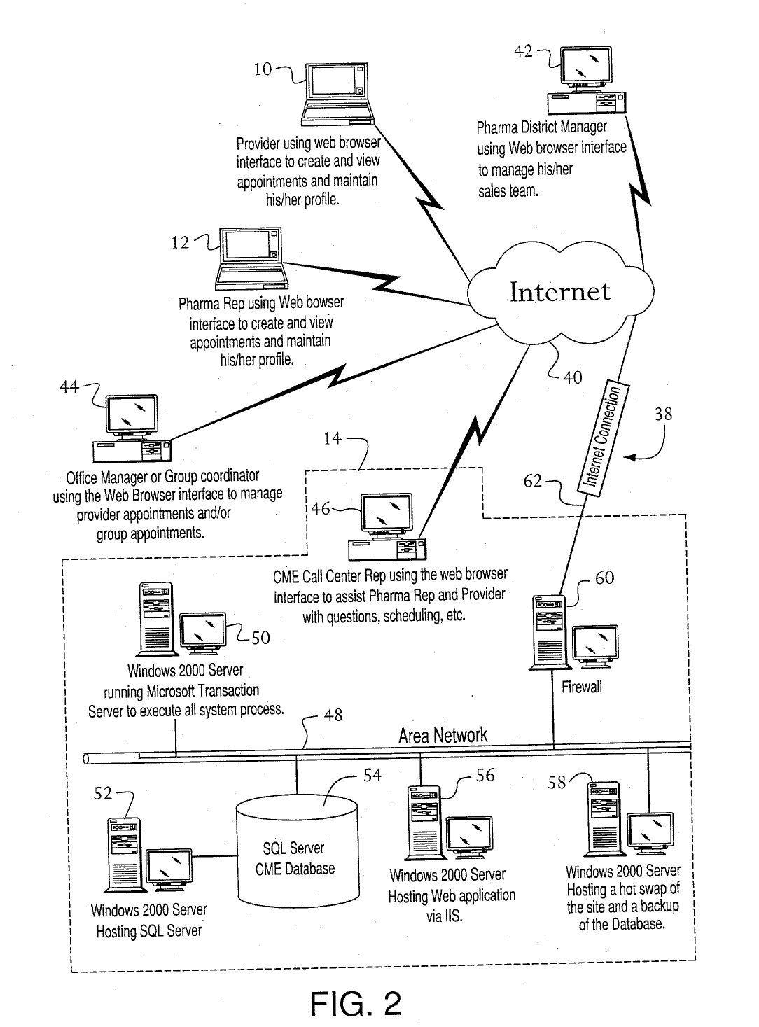

FIG. 2 schematically illustrates a presently preferred system 38 according to the invention. Using the system, healthcare providers, Pharma personnel (including sales representatives, managers and others), healthcare provider personnel (healthcare providers, office managers, group coordinators and others) and CME personnel may interact with one another to effectuate the transactions generally described in FIG. 1 and other transactions discussed in later figures. As noted above, a healthcare provider 10 and a Pharma representative 12 may interact with CME 14 via the Internet, generally depicted by reference numeral 40, using any suitable work station, personal computer, laptop, cellular phone, hand-held device or other wired or wireless device that supports any web browser capable of accessing the Internet. Using similar Internet-capable equipment, other persons having a legitimate business reason to participate in system 38 may also access CME 14. For example, a Pharma district manager 42 may interface with system 38 in order to manage his or her sales force. Similarly, a healthcare provider's office manager or group coordinator 44 may interface with system 38 in order to manage provider appointments or group appointments. Additionally, and preferably, a CME call center representative 46 may interact with the system in order to assist Pharma representatives and healthcare providers with questions they may have, scheduling issues, and so on. For additional convenience, the CME call center representative 46 is also preferably accessible to providers and Pharma via telephone and possibly facsimile.

Any presently available or hereinafter developed hardware and software platforms that are capable of performing the functions prescribed herein may be suitably employed to support system 38 and carry out the method of the present invention. In this regard, CME 14 may employ, among other possible alternatives, a combined hardware and software platform based on the Microsoft® Windows 2000 operating system, a plurality of Windows 2000 Servers for supporting, inter alia, Microsoft® SQL (Structured Query language) Server 2000, Microsoft® IIS (Internet Information Server) and Microsoft® Transaction Server, including the development tools found in Microsoft® Visual Studio® 6.0.

CME 14 may employ any suitable area network 48, e.g., a local area network (LAN) such as Ethernet or the like, metropolitan area network (MAN) or wide area network (WAN), which supports data transmission speeds dictated by the demands of the system, e.g., from about 10 Megabits per second (Mbps) through 10 Gigabits per second (Gbps) or even higher as more rapid area network technology comes online. According to a presently preferred embodiment a plurality of network-compatible servers such as, for example, Windows 2000 Servers, are connected to the area network 48 and at least one database 54 to perform the essential functions of the system and method according to the invention. For instance, a Windows 2000 Server may run a Microsoft® Transaction Server 50 to execute all system processes, another Windows 2000 Server 52 may host a Microsoft® SQL Server 2000 to store and access data residing in a SQL Server CME Database 54 (which database is also preferably used to provide data to other systems that need to interface with the present system), another Windows 2000 Server 56 may host web applications via IIS and, preferably, another Windows 2000 Server 58 may host a hot swap of the CME website and a backup of the database 54. Although depicted as a single database, database 54 may comprise one or more databases that are capable of storing information appropriate to the system and method of the present invention.

A suitable firewall 60 is preferably connected to the area network 48 to prevent unwanted intrusion or corruption of the CME equipment and data. Firewall 60 connects the area network 48 of CME 14 to the Internet 40 via a Internet connection 62. Desirably, Internet connection 62 is a high speed Internet connection. Although slower Internet connections may be employed for this purpose, Internet connection 62 is preferably a T-1 or faster connection in order to accommodate heavy peak system traffic without undue system latency.

Preferably, 3-tiered object oriented application architecture supports the functionality of the CME 14 according to the invention. Such architecture is desirable for its well-known advantages of scalability, modularity and reusable code. 3-tiered architecture is a programming technique that functionally de-couples logical components. This approach provides exceptional ability to scale a solution to the appropriate size and portability. The approach also provides the ability to interchange components. 3-tiered architecture is the separation of a system application into three layers: the Presentation Layer, the Processing Layer and the Data Management Layer which, in the context of the present invention, are discussed below.

### Presentation Layer

The Presentation Layer of the application supports user input and display information. This layer is most often presented as a graphical user interface (GUI) displayed on a personal computer (PC), other user device, over the Internet or on an area network. The presentation layer communicates with the user and passes commands to the processing layer, discussed below, and in return receives information from the processing layer for display to the user. The presentation layer can be “distributed” as in the case of a PC Presentation layer in which a copy resides on each individual remote user machine. Alternatively, it can be “central” as in the case of the Internet where the central copy of the presentation layer resides on one or more remote servers and is accessible by a user via a login/logon and password procedure. The presentation layer provides flexibility in design and deployment by taking advantage of object oriented design which permits changes to be made to the presentation layer without having to modify the other layers.

The presentation layer implemented by CME 14 preferably includes two components. A first component of the presentation layer is the Internet or Web component. The Internet component is desirably a centralized application that resides on a web server and can be accessed by Pharma sales professionals and district managers, doctors, office managers, CME staff, and call center staff through any standard Internet connection. The Web component posts requests to the processing layer for information, updates, and processing. It may utilize hypertext markup language (HTML), Active Server Pages, and JavaScript or any other presently existing or later developed network compatible applications, code or tools in any presently existing or later developed languages to provide an interface that is accessible from any existing and future browser technology. The presentation layer preferably uses ID and Password codes to protect the Internet component in addition to employing firewall 60 and other security measures. The interface will be used to present and accept all information to the users based on their login and password as well as their security level.

A second component of the presentation layer is preferably a distributed GUI written in Microsoft® Visual Basic® or by using other present or future web development tools. Alternatively, the GUI may reside at the call center facility or other convenient location on the network. This component includes forms that present data to and accept data from the call center staff. The GUI also posts requests to the processing layer for information, updates, and processing. In addition, the GUI be used as a backup to allow system 38 to continue in the event that the Internet component is temporarily down.

### Processing Layer

The processing layer possesses operating logic and executes business rules used by the system and method of the present invention. The processing layer is responsible for processing all requests issued by the presentation layer. It also posts requests to and receives data from the data management layer, discussed below, and in some cases may also contain a subset of the data found in the data management layer. The processing layer also preferably employs object oriented design and techniques in order to support a robust and flexible rules engine for processing any functions of system 38. These traits, coupled with the inherent “black box” properties of objects (i.e., the calling program need not know how the results are achieved), give the processing layer a high level of flexibility. This flexibility is further evident in the fact that objects can be changed to function and process differently without having to change the presentation layer or the data management Layer.

Although not limited exclusively thereto, the processing layer according to a presently preferred embodiment is composed of a group of Visual Basic® server objects called ActiveX® dynamic link library (DLL) objects. These DLL objects are a collection of small programs that provide processing of all of the business rules, edits, and functionality of the system 38 according to the invention. In addition, a presently preferred embodiment of the processing layer employs Microsoft® SQL Server-stored procedures to process data. These stored procedures contain logic that will help to determine the results of queries, inputs and deletes.

### Data Management Layer

The data management layer is the central repository for data. Pursuant to a presently preferred construction, this layer resides on a suitable SQL server such as, for example, a Microsoft® SQL Server 2000, to create a high-speed, fault tolerant and SQL-compliant data source. The SQL server processes all SQL requests from the processing layer that involve the storage or retrieval of data. The data management layer employs stored procedures and triggers to process all data events.

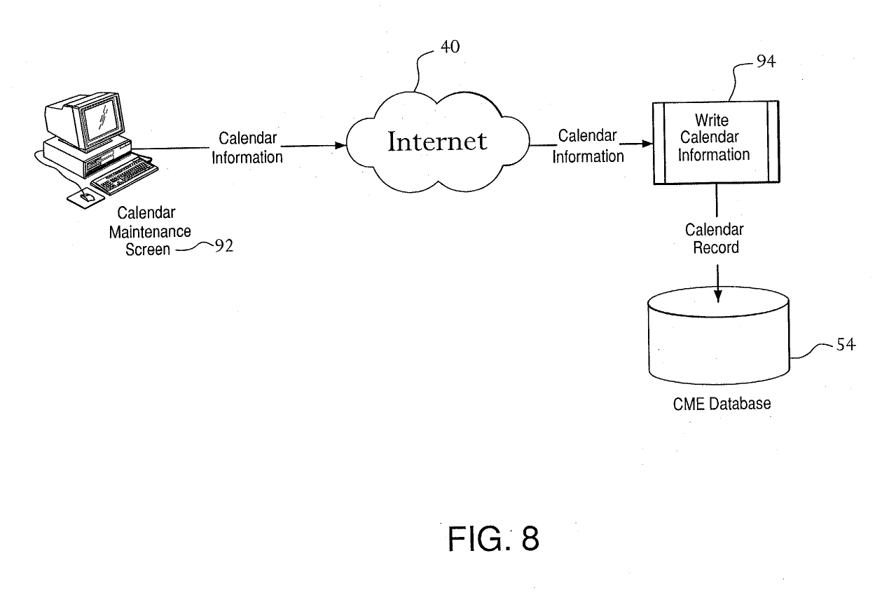

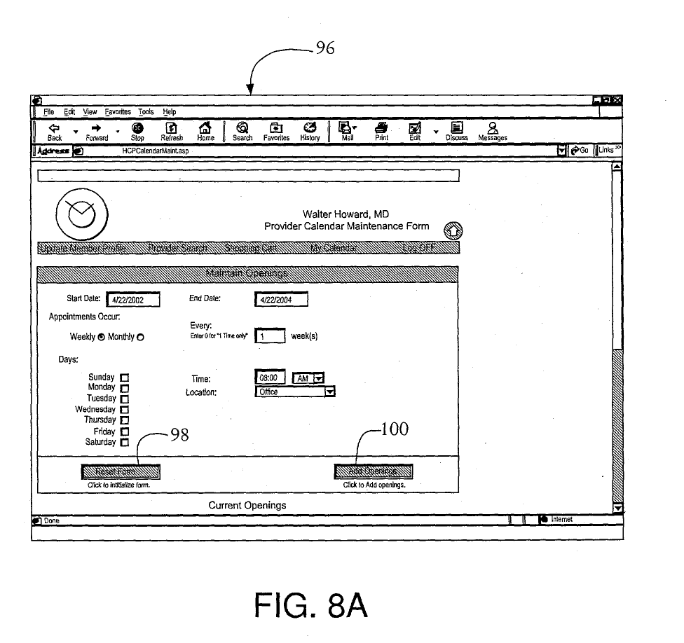

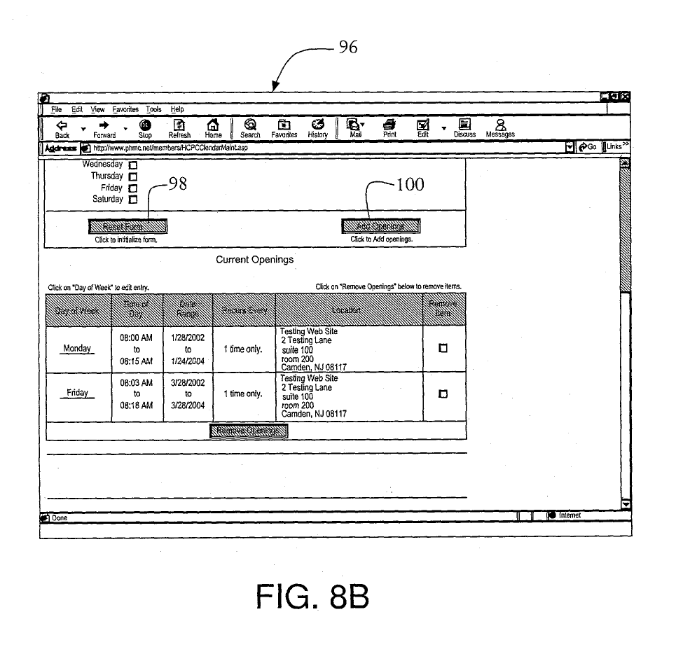

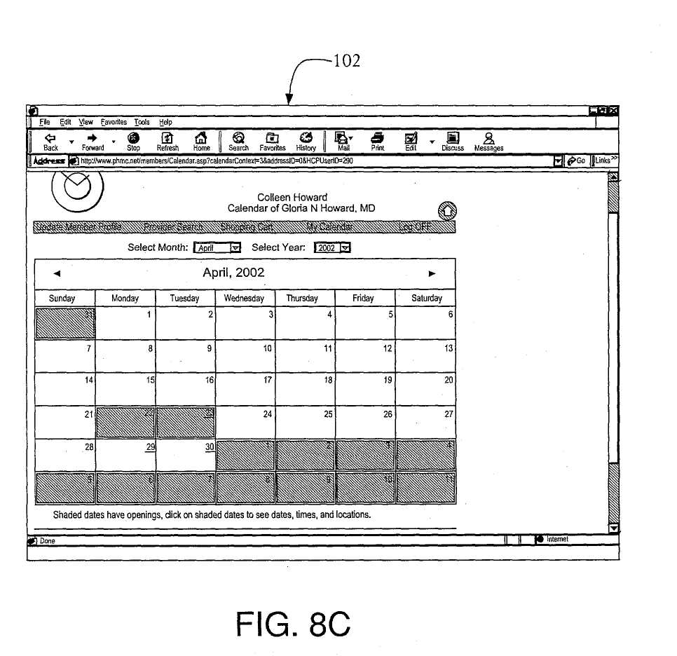

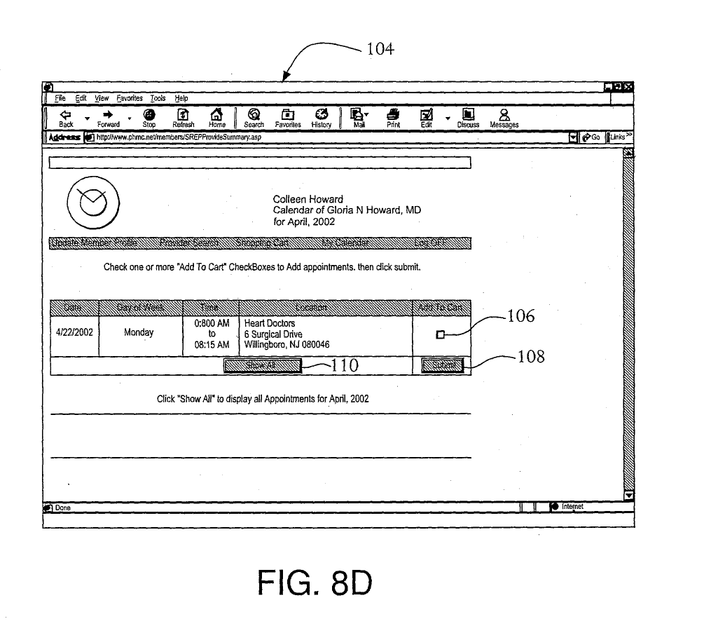

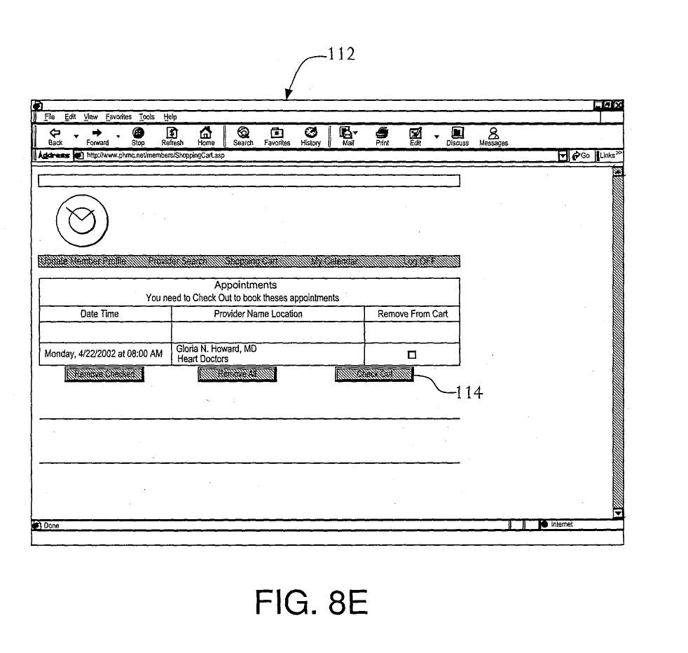

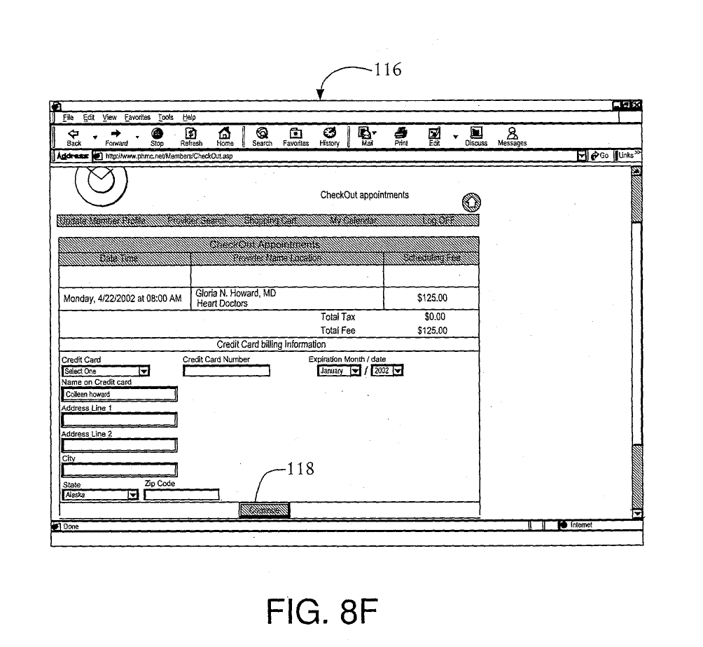

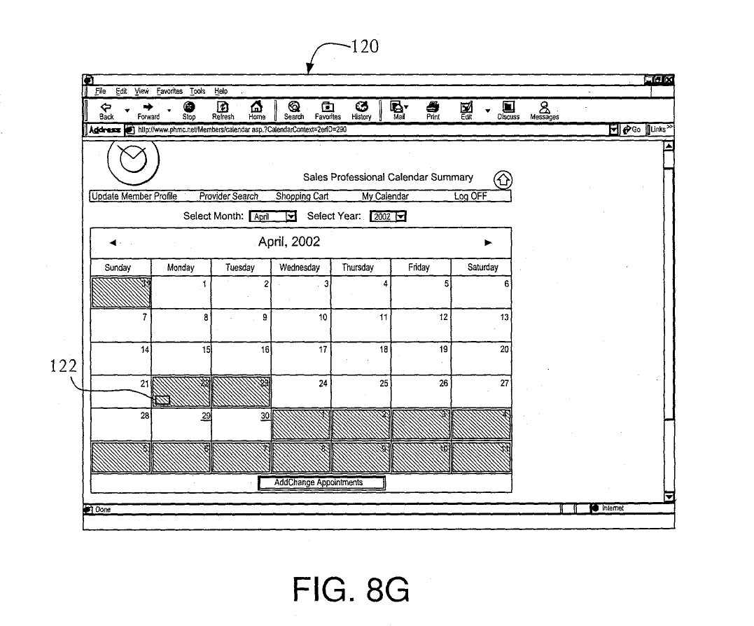

The data management layer also preferably provides replication functionality to synchronize data with external entities such as the CME call center 46 and an accounting branch of system 38 which is described in greater detail in connection with FIG. 8. The replication will primarily be one-way and in the case of the accounting branch should include a subset of the data that resides on the normally active CME database 54. Preferably, there is a facility to replicate from the call center emergency database to the active database as a restoration in case of a disaster.

The preferred system architecture enables development of robust Web-based applications that are critical to seamless electronic commerce. The architecture also allows the CME to modify or change components of its core functionality, add new functionality or delete obsolete functionality without having to redevelop the entire application. The result of this design is a robust application that affords users of system 38 the following features and advantages:

1. Registration and Scheduling Functionalities

Registration/orientation of new healthcare providers and Pharma sales representatives—All healthcare providers and Pharma sales professionals are preferably assigned an identification number. For providers this ID number may be referred to as the Provider Identification Number (PIN). For Pharma sales professionals this ID number may be referred to as the Representative Identification Number (RIN). CME 14 utilizes these PIN and RIN numbers internally to collate data and track information. All registrations can be completed and secured electronically via the CME's web site.

Website tour capability

Member logon

Provider profile sheet (updated by provider, viewed by sales professional or sales professional's Pharma company)

Sales professional profile sheet (updated by sales professional provider, viewed by provider or sales professional's Pharma company)

Personal calendar page (with the ability to create graphs or other meaningful graphic information)

Search function to find a sales professional

Search function to find a provider

Healthcare Provider and Pharma Directories—Pharma sales professionals may search for key healthcare providers with whom they may desire to secure an appointment. Through this mechanism, sales professionals have the ability to define a search by any one or more items of provider information such as provider name, address, city, state, zip code, county, phone number, specialty, and practice name. Even further, Pharma sales professionals preferably will have the ability to create a personalized on-line “key” provider list for speed in navigating the CME website on return visits. Likewise, providers preferably will have the similar ability to search for and contact the appropriate Pharma sales professional(s) for educational products and sample request purposes.

Calendar/Scheduling Program—A formatted, user-friendly calendar system for use by both Pharma representatives and healthcare provider/office staff to easily identify the dates and times the provider chooses to make appointments available. The calendar system offers a real-time view of both the providers and sales professionals personalized calendar schedule(s). The calendar system permits registered participants to manage appointments and schedules as well as track and chart past, present and future appointment information and other data.

Waiting list entry for cancelled appointments

Appointment schedule confirmation (Confirmation Messaging)—Desirably, a message box appears at logon for Pharma sales professionals to indicate confirmation of previously scheduled and completed appointments.

Confirmation of appointment (i.e., was meeting held, cancelled or postponed)

Healthcare provider post-meeting survey—to be completed telephonically, on-line or paper-based

Print screen functionality

Web-based calendar integration with Microsoft® Outlook®, Outlook Express and Lotus Notes® along with current and future client relations managers (CRMs).

2. Provider fair market compensation functionality

Credit card authorization/transactions

Method of fair market compensation to provider

3. Reporting functionalities

To providers

To sales professionals

To Pharma companies/sales district management

4. Email/fax/paper-based/telephonic notifications

Appointment confirmation

Appointment completion verification

Appointment cancellation notification

5. Data Security

Multilevel security with password protection and data encryption capabilities, consistent with industry standards

Referring to FIGS. 3A and 3B, FIG. 3A is a GUI image which represents the “initial registration page” 64 of a presently preferred embodiment of a CME 14 website with which participants of the present system may interact in order to register with the system 38. Initial registration page preferably includes a selection box 66 at which the user may identify himself or herself as a healthcare provider (as illustrated), a Pharma sales professional, a Pharma manager or other such professional. Upon registration, depending on the participant category input by the user into selection box 66, CME 14 automatically avails the user to certain areas of the website which are dedicated to users of the selected participant category. As is typical of online user registration pages, a user enters information such as his of her name and selects and confirms a password. For additional security registration page may also incorporate text boxes in which a user may input private information such as a secret phrase question and answer, family information such as place of birth, mother's maiden name, and so on.

FIG. 3B is a GUI image which represents the “login (or logon) page” 68 the CME 14 website at which previously registered participants of the present system may logon to the system 38. As is conventional, a user may logon at logon page 68 by entering his or her user name and password.

FIG. 4 is a flow chart depicting the manner in which a healthcare provider registers with system 38. Following initial registration at initial registration page 64 wherein a user has identified himself or herself as a healthcare provider, and at each login thereafter, the system application presents the user with a healthcare provider registration screen 70 discussed in greater specificity below. The user then enters his or her registration information. At step 72, using client side scripting another data validation technique the system application attempts to validate the data for content and format. If the data does not pass the validation test the healthcare provider registration screen 70 is redisplayed with an appropriate error message. If the validation is completed without error, the data is passed, via the Internet 40, to a Save Healthcare Provider Registration Information process 74. The Save Healthcare Provider Registration Information process opens a connection to the CME Database (DB) 54. Once the connection is open the application writes the Healthcare Provider Record to the database 54. Each time the healthcare provider wishes to modify his or her personal information the foregoing procedure is repeated.

FIGS. 4A-4E are representations of GUI images of a presently preferred embodiment of a CME website with which healthcare providers may interact in order to input and modify personal information for registration purposes. As seen in FIGS. 4A-4E, registration screen 70 is preferably comprised of a plurality of healthcare provider profile personal information screens 70′, 70″ and 70′″. In these several information screens the provider is presented with multiple text boxes into which he can input registration information concerning himself or herself and his or her practice. Such information may include without limitation, his or her name, title, birth date, social security number, medical school and graduation date, medical specialties, personal and office phone numbers and fax numbers, pager number, cell phone number, personal and office email addresses, number of active patients, the manner he or she may prefer to be compensated for completing Pharma sales representatives appointments and post-appointment surveys, professional and hospital affiliations, availability for after hour pharmaceutical functions and interest in clinical trials, drug enforcement agency (DEA) and state license numbers, office practice names and locations, office manager contact data, whether the practice has Internet access and a website, and whether the practice uses a practice management system (and, if so, which one).

Once a healthcare provider is registered with the present system, he or she may provide CME 14 with certain dates, times and places that he or she is willing to meet Pharma sales representatives for sales appointments. In addition, registered providers may have access to valuable data warehoused by the CME including but not limited to:

1. Available vs. scheduled appointments

a. Weekly

b. Monthly

c. Quarterly

d. Yearly

2. Potential personal revenue (as per available appointments)

a. Monthly

b. Quarterly

c. Yearly

3. Differentiation of past and presently scheduled appointments

a. By Sales Rep Name

b. By Pharma Company Name

c. By Pharma Company Type: Pharma, Bio, medical device, etc.

d. By Sales Rep Specialty

4. Volume of Sales Professionals registered with CME

a. By Pharma Company Name

b. By Sales Specialty

c. By Pharma Company Type

d. By State, Region or Geographic Location

5. Sorting of Pharma companies and sales professional by drug, supply, medical device or other product

FIG. 5 is a flow chart depicting the manner in which a Pharma sales representative registers with system 38. Similar to the registration procedure for healthcare providers discussed above, following initial registration at initial registration page 64 wherein a user has identified himself or herself as a Pharma sales representative, and at each login thereafter, the system application presents the user with a Pharma sales representative registration screen 76 discussed in greater specificity below. The user then enters his or her registration information. At step 78, using client side scripting another data validation technique the system application attempts to validate the data for content and format. If the data does not pass the validation test the Pharma sales representative registration screen 76 is redisplayed with an appropriate error message. If the validation is completed without error, the data is passed, via the Internet 40, to a Save Pharma Sales Representative Registration Information process 80. The Save Healthcare Provider Registration Information process opens a connection to the CME Database (DB) 54. Once the connection is open the application writes the Pharma Sales Representative Record to the database 54. Each time the Pharma sales representative wishes to modify his or her personal information the foregoing procedure is repeated.

FIGS. 5A-5C are representations of GUI images of a presently preferred embodiment of a CME website with which Pharma sales representatives may interact in order to input and modify personal information for registration purposes. As seen in FIGS. 5A-5C, registration screen 76 is preferably comprised of a plurality of healthcare provider profile personal information screens 76′ and 76″. In these several information screens the Pharma sales representative is presented with multiple text boxes into which he can input registration information concerning himself or herself and the Pharma company he or she represents. Such information may include without limitation, his or her name, employment date, present and past position/title, educational degree, personal and office phone numbers and fax numbers, pager number, cell phone number, personal and office email addresses, general personal information and professional affiliations.

Once a Pharma sales representative is registered with the present system, he or she may schedule appointments to meet with healthcare providers through CME 14. In addition, registered Pharma sales representative may use the system to make queries of healthcare providers based on one or more provider personal profile data including but not limited to:

State

Territory

Region

Specialty

Clinical trial interest

After hour Pharma function interest

Patient practice size

State licensure

Single vs. multiple practice locations

Available appointment times

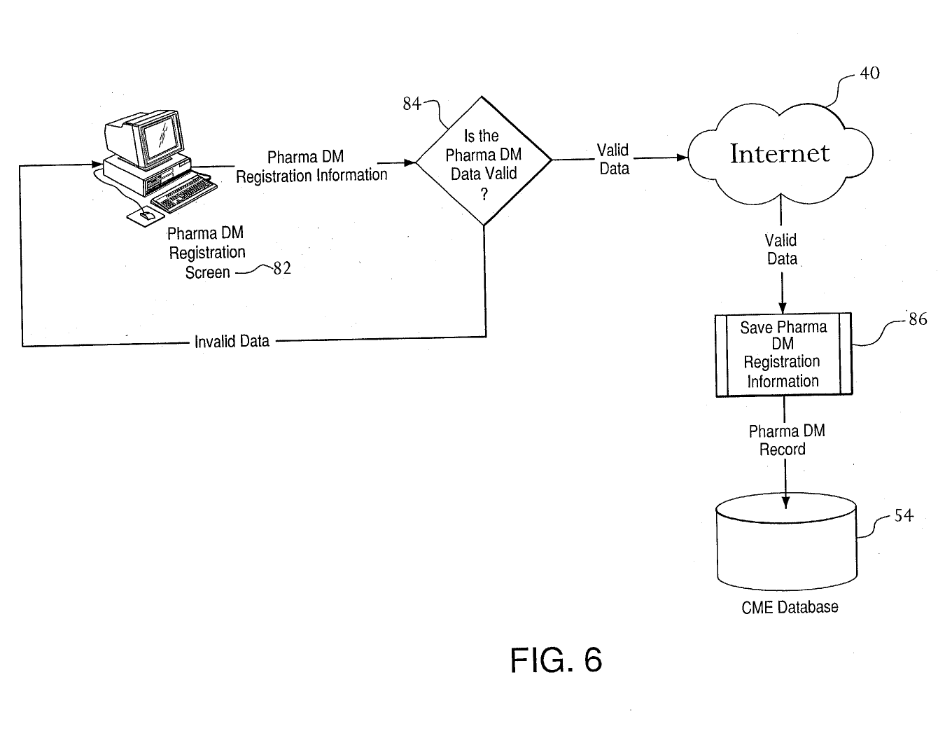

FIG. 6 is a flow chart depicting the manner in which a Pharma district manager or other member of Pharma sales force management registers with system 38. Similar to the registration procedure for healthcare providers and Pharma sales representatives discussed above, following initial registration at initial registration page 64 wherein a user has identified himself or herself as a Pharma district manager, and at each login thereafter, the system application presents the user with a Pharma district manager (DM) registration screen 82. Although not illustrated in detail, the Pharma DM registration screen 82 contains text boxes that are tailored for the Pharma DM to input personal data similar to the kinds discussed above for Pharma sales representatives. The user then enters his or her registration information. At step 84, using client side scripting another data validation technique the system application attempts to validate the data for content and format. If the data does not pass the validation test the Pharma DM registration screen 82 is redisplayed with an appropriate error message. If the validation is completed without error, the data is passed, via the Internet 40, to a Save Pharma DM Registration Information process 86. The Save Pharma DM Registration Information process opens a connection to the CME Database (DB) 54. Once the connection is open the application writes the Pharma DM Record to the database 54. Each time the Pharma DM wishes to modify his or her personal information the foregoing procedure is repeated.

The system allows Pharma sales management authorized access to view appointment calendars of their respective sales forces' past, present and future appointment information and other data. In addition, Pharma sales management can make raw and statistical data queries concerning their respective professional sales force including but not limited to:

1. Scheduled and cancelled appointments

a. Scheduled appointments for individual sale representatives and groups of representatives (both appointments pending and completed)

1. Per day

2. Per week

3. Per month

4. Per quarter

5. Per year

6. By provider specialty

7. By territory

8. By region

9. By state

b. Cancelled appointments

1. Per week

2. Per month

3. Per quarter

4. Per year

5. Per sales professional

6. Per territory

7. Per region

8. Per state

9. Per sales specialty

10. Per provider specialty

c. Dollars Spent By sales professional, territory, region and/or sales specialty (pending and completed appointments)

1. Per Day

2. Per week

3. Per month

4. Per quarter

5. Per year

6. Per provider name

7. Per practice group/name

8. Per provider specialty

2. Sales Professional scheduling time on system

a. Average number of appointments scheduled/dollars spent per visit to site

1. Individual

2. Competition

b. Average number of appointments in calendar (both their own and their competitors' sales forces)

1. Per day

2. Per week

3. Per Month

4. Per quarter

5. Per year

6. By sales specialty

7. By Region

8. By State

3. Most visited/scheduled providers

a. Per Specialty

b. Per Region

c. Per State

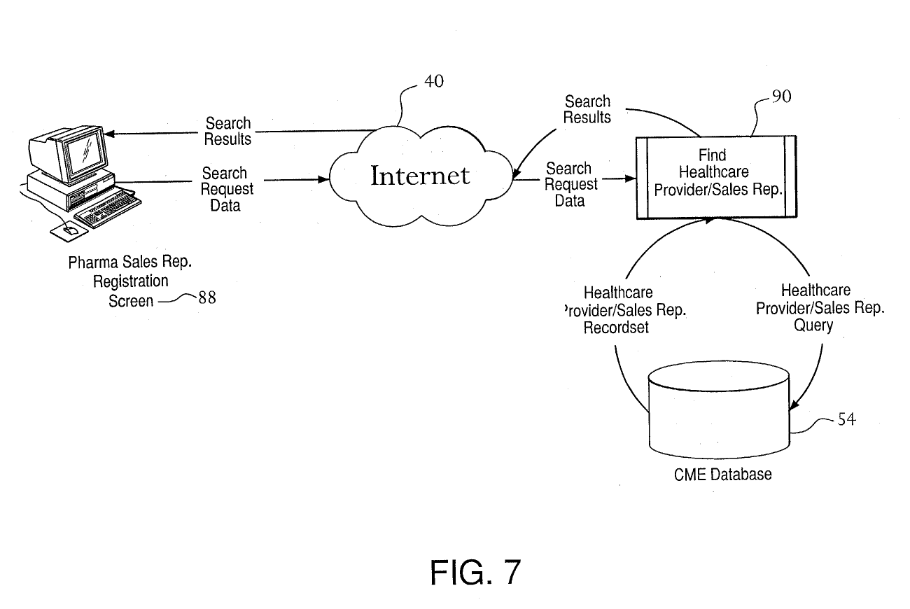

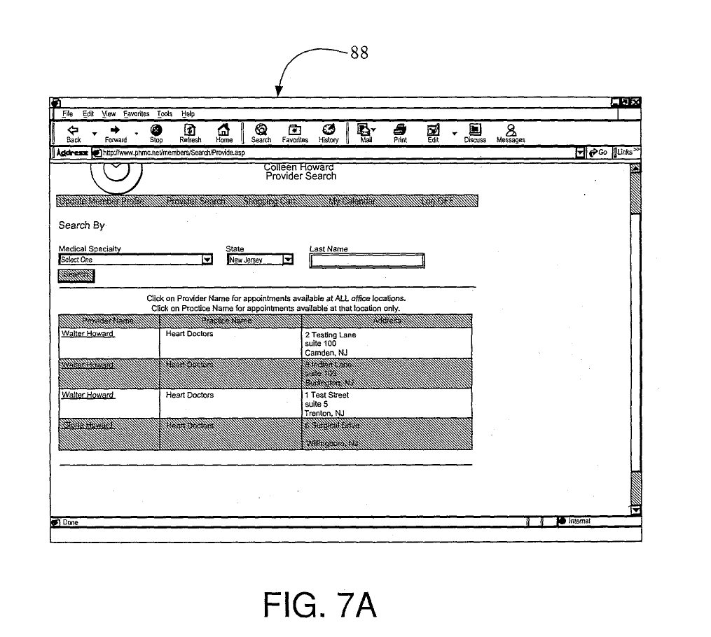

System 38 also preferably allows both Pharma representatives and healthcare providers to search for specific members of the other professional community. In this regard, FIG. 7 is a flow chart depicting the manner in which healthcare providers and Pharma sales representatives may search for specific members of the other community that are participants in the system. The system desirably provides view-only access to help the provider or Pharma representative to better understand the background and history of the personnel involved in their prospective appointment or meeting. When a user wishes to research one or more members of the other community, the system application presents the user with a reference look up screen 88 which allows the user to enter the desired search criteria. The application then passes that request via the Internet 40 to the CME to a Find Healthcare Provider/Sales Professional process 90, which opens a connection to the CME Database (DB) 54 and posts the query. The Healthcare Provider/Sales Professional record set obtained form database 54 is then returned by the CME through the Internet 40 to reference look up screen 88.

FIG. 7A is an example of a reference look up screen 88 that enables a Pharma sales representatives to search for specific healthcare providers. As shown in FIG. 7A, a Pharma representative may search for healthcare providers using any desired search criteria including without limitation, medical specialty, state and last name. It will be understood that the search criteria presented by the reference look up screen 88 will of course vary depending on whether the inquiring user is a healthcare provider or a Pharma representative and that such search criteria may include any criteria that renders it easy for the user to retrieve the desired results.

FIG. 8 is a flow chart depicting the manner in which healthcare providers or their office managers may input providers' appointment scheduling availability into the system. As shown in FIG. 8, the system application presents the provider or his or her office manager with a calendar maintenance screen 92 that allows the user to enter the place, dates and times he or she is available to take appointments. The provider or his or her office manager enters the provider's availability and the information is passed via the Internet 40 to the write calendar process 94. The write calendar process opens a connection to the CME database (DB) 54 and writes the calendar record. The information is later accessed by Pharma sales professionals/representatives to ascertain the provider's availability and to schedule appointments with the provider.

FIGS. 8A-8E are examples of interactive GUI screens with which healthcare providers or their office managers may input and modify the providers' appointment scheduling availability and with which Pharma sales representatives may schedule appointments with healthcare providers.

Referring to FIGS. 8A and 8B, there is shown a provider calendar maintenance from screen 96 which includes several text boxes and check boxes into which a healthcare provider or his or her office manager may input information including but not limited to appointment range start and end dates, weekly of monthly calendar frames, whether the desired appointments are to be reserved for a single week or over repeated for several weeks, which days of the week appointments may be scheduled, which time the appointments the appointments may be scheduled and the place at which the appointment are to be conducted. Screen 96 preferably includes a “Reset Form” button 98 to permit the user to initialize the form or clear the information inputted into the screen. When the user is satisfied with the inputted appointment schedule information, he or she then clicks on an “Add Openings” button 100 to transmit the preferred appointment slots via the Internet to CME 14 whereby they may be accessed and reserved by interested Pharma sales professionals. As seen in FIG. 8B, the appointment listing or slots provided by the healthcare provider or his or her office manager are reflected as “Current Openings”. If incorrect, or if they are to be cancelled, one ore more of the Current Openings may be edited or deleted as desired by the healthcare provider or his or her office manager.

FIG. 8C shows a provider calendar availability screen 102 that may be accessed by a Pharma sales representative to determine the appointment availability a particular healthcare provider. At screen 102, the Pharma sales representative selects the month and year of interest and screen 102 returns a calendar showing the days of that month for which the desired provider is available for an appointment. Available appointment dates may appear as colorized, shaded or otherwise highlighted days. In the present example, screen 102 indicates that the selected healthcare provider is available for appointments on the 22^{nd} and 23^{rd} days of April 2002. The interested Pharma sales representative may then select one or more of the availability dates to obtain further information about the specific time slots on such date(s) that the provider has allotted for potential appointments with Pharma representatives and is then presented with a screen similar to that shown in FIG. 8D.

In the example shown in FIG. 8D, the Pharma sales representative has selected the date of Apr. 22, 2002 from screen 102 and is presented with an appointment screen 104 which displays all of the healthcare provider's allotted Pharma sales appointment time slots for that date. If a displayed time slot is compatible with the Pharma sales representative's schedule, he or she may reserve that allotted appointment time by selecting the appointment by a clicking on “Add to cart” or similar selection box 106 and submitting the selection to the CME by activating a “Submit” or similar button.

If no displayed time slots form screen 104 are compatible with the Pharma sales representative's schedule, he or she may return to provider calendar availability screen 102 of FIG. 8C by clicking on the “Back” button on his web browser or by clicking on the “Show All” button or similarly operative button 110 of screen 104.

If the Pharma sales representative has selected one or more available appointment slots from screen 104 of FIG. 8D, he or she is then presented with an appointment shopping cart or similar screen 112 such as that shown in FIG. 8E. At screen 112, the Pharma sales representative may then remove one or more of his or her selected appointments. If, however, the Pharma sales representative is satisfied with the selection(s), he or she clicks on a “Check Out” or similar button 114 at which point he or she is presented with a “Check Out Appointments” or similar screen 116 of FIG. 8F.

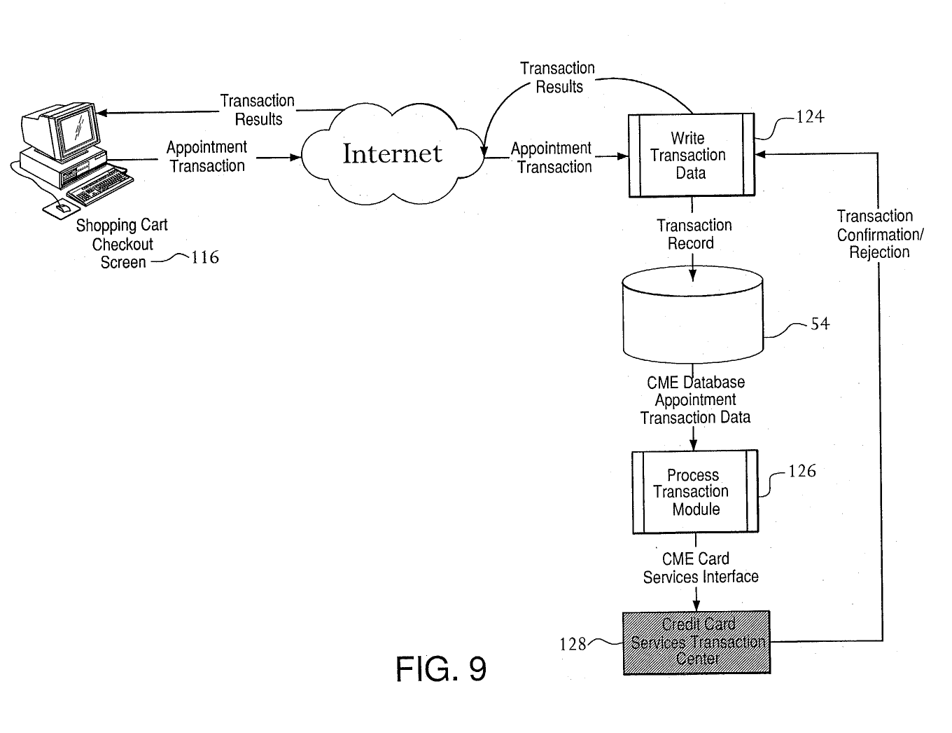

At screen 116, the user is presented with a listing of his or her appointment selections and is presented with several text boxes into which he or she enters credit card account information as well as personal information such as name, address and the like. Once the requisite information has been inputted into the text boxes of screen 116, the user clicks on a “Continue” or similar button 118 to conclude the transaction and initiate the automatic billing procedure described below in connection with FIG. 9. The credit card information supplied at screen 116 enables the CME to automatically bill the Pharma sales representative or his or her company automatically for the scheduled appointment(s) at the conclusion of the check out process. At this point, the CME confirms the appointment in both the healthcare provider's and the Pharma sales representative's online calendars. An example of such calendar confirmation is depicted in FIG. 8G.

As shown in that figure, a sales professional calendar summary screen or similar 120 reflects that at least one appointment has been scheduled by the Pharma sales representative on Apr. 22, 2002 by virtue of an appointment indicator symbol 122 superimposed on that calendar date. A similar appointment indicator will correspondingly appear on an unillustrated healthcare calendar summary screen that may be accessed by the affected provider or his or her office manager. Additional confirmation may optionally be provided by automatic electronic mail or fax confirmation delivered by the CME to either or both of the healthcare provider and the Pharma sales representative.

Moreover, system 38 preferably offers the Pharma sales representative at appropriate locations in the appointment scheduling process, e.g., at one or more of screens 104, 112 and/or 116 or elsewhere, hyperlinks to free online map and/or directions assistance websites that enable the Pharma sales representative to easily locate the site of the appointment.

As mentioned above, once the Pharma sales representative selects the desired appointment(s) and adds it/them to the shopping cart, he or she then clicks the checkout button and the system application presents the user with the checkout screen 116. The user then enters all required personal and credit card information described above. As illustrated in FIG. 9, when the user concludes the transaction, the system application passes the transaction, via the Internet 40, to a write transaction data process 124. This process opens a connection to the CME database (DB) 54 and writes the appointment and transaction data to the database. The system application then calls a process transaction module 126 which uses a card services solution development kit or similar application to interface with a credit card services transaction center 128. The credit card services transaction center 128 processes the transaction and returns the results to the write transaction data process 124. The system application then sends the confirmation or rejection via the Internet to the presentation layer which displays it to the user.

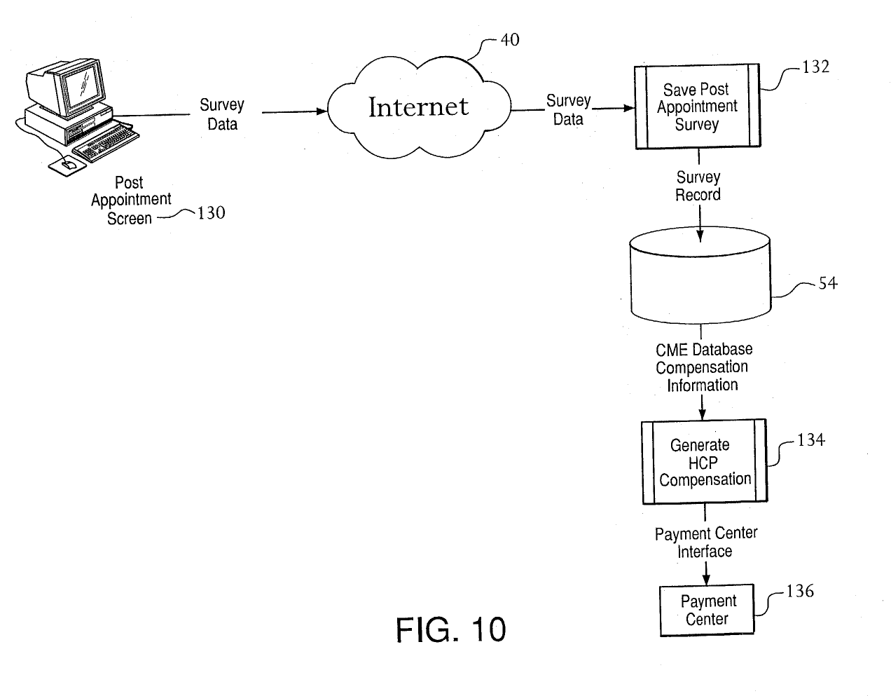

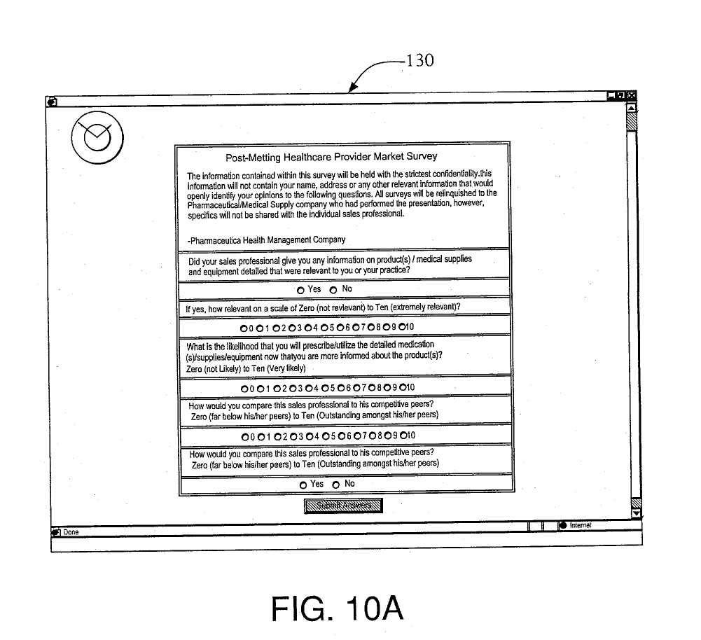

According to a presently preferred embodiment of the invention, healthcare provider compensation is predicated on the provider completing not only the scheduled appointment with a Pharma sales representative but also completion and submission of a post-appointment survey to CME 14. If the survey is not completed the healthcare provider is not compensated for the appointment. Once the appointment is completed, the healthcare provider submits a post-employment survey either in paper form submitted to the CME 14 via fax or conventional postal services, verbally via a telephonic interview with a CME 14 representative or online via the Internet. According to a presently preferred embodiment of the invention, once the date and time of the appointment has passed, a healthcare provider accesses system 38 via the Internet. He or she is then presented with an icon on his or her personal calendar (not illustrated) that links to a post-appointment survey screen 130, a non-limiting example of which is shown in greater detail in FIG. 10A. The user completes the survey and the information is passed via the Internet 40 to a post appointment survey process 132. This process opens a connection to the CME database (DB) 54. The process then writes a survey record to the database using a CME-generated appointment identifier (ID) to link the survey to a specific appointment and the healthcare provider ID to a specific provider. At the end of the month or other time frame and billing cutoff date, a generate healthcare provider compensation process 134 determines the compensation payable to the provider based on appointments and surveys completed. The information is then passed to a payment center application 136 of CME 14 which populates appropriate accounting tables with information concerning the transaction(s) and fees payable to the provider. In addition, the payment center application 136 is preferably configurable to pay the appointment fees to a provider, at the provider's option, via an electronic deposit to an account of the provider's choice or via check or similar means of payment.

As shown in FIG. 10A, the post-appointment survey screen 130 includes questions concerning the effectiveness of a Pharma sale representative's effectiveness during the time spent with a healthcare provider during a particular appointment session. The results of the surveys are stored on the CME database 54 and are preferably accessible to Pharma sales force management via system 38 whereby they can objectively evaluate the effectiveness of their sales force in promoting the Pharma company's products.

The present invention realizes many concrete, tangible and useful results that inure to the benefit of healthcare providers, Pharma sales representatives and Pharma companies. Among its many advantages, the present invention pays healthcare providers fair market value for time spent with Pharma representatives while providing Pharma of all sizes and marketing budgets fair and equal access to providers. It also endeavors to assure that the time healthcare providers spend with members of Pharma is effectively managed to create a long-term benefit that will increase the providers' knowledge of prescription products, thereby potentially decreasing medication errors, decreasing adverse drug related (ADR) events. It also increases cost efficiencies and decreases therapeutic overlap/duplications. The present model further offers providers an off-line and/or web-enabled solution that continuously manages the administrative scheduling of Pharma sales professionals (i.e., 24 hours a day/7 days a week/365 days a year) and offers both the healthcare provider and Pharma a concise profile of the Pharma sales professional and the healthcare provider with whom they respectively will be meeting.

In addition, the system and method according to the invention allows providers to more efficiently operate their practice through a reduction in administrative functions and time expenditures. It also enables Pharma company management to utilize formerly uncaptured information regarding the scheduling activities and efficiencies of their specific sales professionals and those of their competitors on a real-time basis.

In addition, the present invention represents an unbiased third party time management service model that meets the stringent criteria of the U.S. Department of Health and Human Services (HHS), the Office of the Inspector General (OIG), Stark (Stark laws were introduced by the OIG as a compliance program for the healthcare industry), Anti-kickback, Medicare/Medicaid Fraud and Abuse, the Health Insurance Portability and Accountability Act of 1996 (HIPAA), the Centers for Medicare and Medicaid Services (CMS) and other state and federal rules and regulations.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A system for managing interactions between healthcare providers and Pharma companies comprising:
at least one computer-readable database populated with data comprising:
enrollment information and appointment information of healthcare providers and Pharma company representatives; and
accounting information including fees chargeable to Pharma companies or their representatives for appointments scheduled between healthcare providers and Pharma company representatives and fees payable to healthcare providers for said appointments; and
computer means for processing said data and for managing interactions between healthcare providers and Pharma companies.

2. The system of claim 1 wherein the Pharma companies are selected from the group consisting essentially of pharmaceutical, biotechnology, medical supply and lab companies.

3. The system of claim 1 wherein the healthcare providers are selected from the group consisting essentially of individual healthcare specialists, providers or ancillary providers, hospitals, teaching institutions, assisted care facilities, skilled care facilities, nursing home facilities, Independent Physicians Associations, Managed Care Organizations and Management Service Organizations.

4. The system of claim 1 wherein said computer means is accessible by healthcare providers, Pharma company representatives and other persons via the Internet.

5. The system of claim 1 wherein the Pharma company representatives include sales staff and management personnel.

6. The system of claim 1 wherein said data further comprise survey information gathered from healthcare providers following appointments between healthcare providers and Pharma company sales representatives, said computer means being further operable to process said survey information.

7. A system for managing interactions between healthcare providers and Pharma companies comprising:
means for processing enrollment information of healthcare providers and Pharma company representatives;
means for processing appointment information of healthcare providers and Pharma company representatives;
means for processing accounting information including fees chargeable to Pharma companies or their representatives for appointments scheduled between healthcare providers and Pharma company representatives and fees payable to healthcare providers for said appointments; and
database means for storing said enrollment information, said appointment information and said accounting information in computer-readable form.

8. The system of claim 7 wherein the Pharma companies are selected from the group consisting essentially of pharmaceutical, biotechnology, medical supply and lab companies.

9. The system of claim 7 wherein the healthcare providers are selected from the group consisting essentially of individual healthcare specialists, providers or ancillary providers, hospitals, teaching institutions, assisted care facilities, skilled care facilities, nursing home facilities, Independent Physicians Associations, Managed Care Organizations and Management Service Organizations.

10. The system of claim 7 further comprising means for enabling access to said system by healthcare providers, Pharma company representatives and other persons via the Internet.

11. The system of claim 7 wherein the Pharma company representatives include sales staff and management personnel.

12. The system of claim 7 further comprising means for processing survey information gathered from healthcare providers following appointments between healthcare providers and Pharma company sales representatives.

13. A system for managing interactions between healthcare providers and Pharma companies comprising:
user interface means for enabling healthcare providers and Pharma company representatives to communicate with said system;
first processing means for processing enrollment information received from healthcare providers and Pharma company representatives;
second processing means for processing appointment information received from healthcare providers and Pharma company representatives;
third processing means for processing accounting information, said third processing means being operable to charge fees to Pharma companies or their representatives for appointments scheduled between healthcare providers and Pharma company representatives and to pay fees to healthcare providers for said appointments; and
database means for storing said enrollment information, said appointment information and said accounting information in computer-readable form.

14. The system of claim 13 wherein the Pharma companies are selected from the group consisting essentially of pharmaceutical, biotechnology, medical supply and lab companies.

15. The system of claim 13 wherein the healthcare providers are selected from the group consisting essentially of individual healthcare specialists, providers or ancillary providers, hospitals, teaching institutions, assisted care facilities, skilled care facilities, nursing home facilities, Independent Physicians Associations, Managed Care Organizations and Management Service Organizations.

16. The system of claim 13 wherein said user interface means enables access to said system by healthcare providers, Pharma company representatives and other persons via the Internet.

17. The system of claim 13 wherein the Pharma company representatives include sales staff and management personnel.

18. The system of claim 13 further comprising fourth processing means for processing survey information gathered from healthcare providers following appointments between healthcare providers and Pharma company sales representatives.

19. The system of claim 13 wherein said third processing means charges a fee to a Pharma company or its representative upon scheduling of an appointment between a healthcare provider and a Pharma company representative.

20. The system of claim 13 wherein said third processing means pays a fee to a healthcare provider upon completion of an appointment scheduled between a healthcare provider and a Pharma company representative.

21. The system of claim 20 further comprising a central management entity responsible for implementing said system, wherein said third processing means pays a fee to a healthcare provider upon submission of a post-appointment survey by the healthcare provider to said central management entity.

22. A system for managing interactions between healthcare providers and Pharma companies comprising:
participant healthcare providers;
participant Pharma companies; and
a central management entity implementing:
(1) at least one computer-readable database populated with data comprising:
enrollment information and appointment information of said healthcare providers and said Pharma company representatives; and
accounting information including fees chargeable to said Pharma companies or their representatives for appointments scheduled between said healthcare providers and said Pharma company representatives and fees payable to said healthcare providers for said appointments; and
(2) computer means for processing said data and for managing interactions between said healthcare providers and said Pharma companies.

23. The system of claim 22 wherein said Pharma companies are selected from the group consisting essentially of pharmaceutical, biotechnology, medical supply and lab companies.

24. The system of claim 22 wherein said healthcare providers are selected from the group consisting essentially of individual healthcare specialists, providers or ancillary providers, hospitals, teaching institutions, assisted care facilities, skilled care facilities, nursing home facilities, Independent Physicians Associations, Managed Care Organizations and Management Service Organizations.

25. The system of claim 22 further comprising means for enabling said healthcare providers, said Pharma company representatives and other persons to access said computer means via the Internet.

26. The system of claim 22 wherein said Pharma company representatives include sales staff and management personnel.

27. The system of claim 22 wherein said computer means comprise means for paying a fee to a healthcare provider upon completion of an appointment scheduled between the healthcare provider and a Pharma company representative.

28. The system of claim 22 wherein said data further comprise survey information gathered by said central management entity from said healthcare providers following appointments between said healthcare providers and said Pharma company sales representatives, said computer means being further operable to process said survey information.

29. The system of claim 28 wherein said computer means comprise means for paying a fee to a healthcare provider upon submission of a post-appointment survey by the healthcare provider to said central management entity.

30. The system of claim 22 wherein said computer means comprise means for charging a fee to a Pharma company or its representative upon scheduling of an appointment between a healthcare provider and the Pharma company representative.

31. A computer-implemented method of managing interactions between healthcare providers and Pharma companies comprising:
providing at least one computer-readable database populated with data comprising:
enrollment information and appointment information of healthcare providers and Pharma company representatives; and
accounting information including fees chargeable to Pharma companies or their representatives for appointments scheduled between healthcare providers and Pharma company representatives and fees payable to healthcare providers for said appointments; and
processing said data using a computer in order to manage interactions between healthcare providers and Pharma companies.

32. The method of claim 31 wherein the Pharma companies are selected from the group consisting essentially of pharmaceutical, biotechnology, medical supply and lab companies.

33. The method of claim 31 wherein the healthcare providers are selected from the group consisting essentially of individual healthcare specialists, providers or ancillary providers, hospitals, teaching institutions, assisted care facilities, skilled care facilities, nursing home facilities, Independent Physicians Associations, Managed Care Organizations and Management Service Organizations.

34. The method of claim 31 further comprising enabling access to said computer means by healthcare providers, Pharma company representatives and other persons via the Internet.

35. The method of claim 31 wherein the Pharma company representatives include sales staff and management personnel.

36. The method of claim 31 wherein said data further comprise survey information gathered from healthcare providers following appointments between healthcare providers and Pharma company sales representatives, said computer means being further operable to process said survey information.

37. A method of managing interactions between healthcare providers and Pharma companies comprising:
gathering enrollment information from healthcare providers and Pharma company representatives;
gathering appointment information from healthcare providers and Pharma company representatives;
generating accounting information including fees chargeable to Pharma companies or their representatives for appointments scheduled between healthcare providers and Pharma company representatives and fees payable to healthcare providers for said appointments; and
storing said enrollment information, said appointment information and said accounting information in a database hosted on a computer-readable medium.

38. The method of claim 37 wherein the Pharma companies are selected from the group consisting essentially of pharmaceutical, biotechnology, medical supply and lab companies.

39. The method of claim 37 wherein the healthcare providers are selected from the group consisting essentially of individual healthcare specialists, providers or ancillary providers, hospitals, teaching institutions, assisted care facilities, skilled care facilities, nursing home facilities, Independent Physicians Associations, Managed Care Organizations and Management Service Organizations.

40. The method of claim 37 further comprising enabling access to said system by healthcare providers, Pharma company representatives and other persons via the Internet.

41. The method of claim 37 wherein the Pharma company representatives include sales staff and management personnel.

42. The method of claim 37 further comprising gathering survey information from healthcare providers following appointments between healthcare providers and Pharma company sales representatives.

43. The method of claim 37 further comprising charging a fee to a Pharma company or its representative upon scheduling of an appointment between a healthcare provider and a Pharma company representative.

44. The method of claim 37 further comprising paying a fee to a healthcare provider upon completion of an appointment scheduled between a healthcare provider and a Pharma company representative.

45. The method of claim 44 further comprising paying said fee to a healthcare provider upon submission of a post-appointment survey by the healthcare provider to a central management entity responsible for implementing said method.

46. The method of claim 45 wherein a healthcare provider submits said post-appointment survey via the Internet.

47. The method of claim 45 wherein a healthcare provider telephonically submits said post-appointment survey.

48. The method of claim 45 wherein a healthcare provider submits said post-appointment survey via fax.
